(19) United States
(12) Patent Application Publication
(10) Pub. No.: US 2014/0367442 A1
(43) Pub. Date: Dec. 18, 2014

(54) STAPLE CARTRIDGE, STAPLER, AND INTERFACE

(71) Applicant: ACCO Brands Corporation, Lake Zurich, IL (US)

(72) Inventors: Peeyush P. Gadekar, Buffalo Grove, IL (US); Jason B. Magid, Wheeling, IL (US)

(21) Appl. No.: 14/301,674

(22) Filed: Jun. 11, 2014

Related U.S. Application Data
(60) Provisional application No. 61/834,545, filed on Jun. 13, 2013.

(51) Int. Cl. B25C 5/04; B25C 5/16

(52) U.S. Cl. CPC B25C 5/04; B25C 5/16
USPC 227/82; 206/340

(57) ABSTRACT

A stapler includes a base, a head movably coupled to the base and including a magazine assembly, a driver mechanism operable to drive a staple from the magazine assembly, and a cartridge configured to receive a roll of staples, the cartridge cooperating with the magazine assembly to define an interface. The interface includes a channel of the magazine assembly configured to slidably receive a forward end of the cartridge, a non-latching-type engagement configured to inhibit sliding movement between the cartridge and the magazine assembly, and a latching-type engagement configured to retain the cartridge in fixed relationship to the magazine assembly.

### CROSS-REFERENCE TO RELATED APPLICATIONS

This application is a non-provisional of U.S. Provisional Patent Application 61/834,545, filed Jun. 13, 2013, the entire contents of which are incorporated by reference herein.

### BACKGROUND

The present invention relates to staplers and staple cartridges for loading staples into staplers.

### SUMMARY

In one aspect, the invention provides a stapler having a base, a head movably coupled to the base and including a magazine assembly, a forming and driving mechanism operable to form and drive a staple from the magazine assembly, and a cartridge configured to receive a roll of staples, the cartridge cooperating with the magazine assembly to define an interface. The interface includes a channel of the magazine assembly configured to slidably receive a forward end of the cartridge, a non-latching-type engagement configured to inhibit sliding movement between the cartridge and the magazine assembly, and a latching-type engagement configured to retain the cartridge in fixed relationship to the magazine assembly.

In another aspect, the invention provides a staple cartridge configured for storing and dispensing staples in a stapler. The staple cartridge includes a top, a bottom, and left and right sides. A forward end of the cartridge has an opening to dispense staples, and a rearward end of the cartridge has an interior space configured to hold a roll of staples having a transverse axis. A first set of engaging features includes at least one of posts and recesses provided on the left and right sides. A second engaging feature is provided as a latching member positioned at a rearward position along the bottom of the cartridge. The latching member is configured to engage a corresponding latching member of the stapler.

Other aspects of the invention will become apparent by consideration of the detailed description and accompanying drawings.

### BRIEF DESCRIPTION OF THE DRAWINGS

FIG. 1 is a perspective view of a stapler according to one embodiment of the present invention.

FIG. 2 is a perspective view of the stapler of FIG. 1, with a front sheath and cover panel of the stapler detached to permit viewing of the internal components.

FIG. 3 is a cross-section view of the stapler, taken along line 3-3 of FIG. 1.

FIG. 4 is a perspective view showing insertion of a staple cartridge into a magazine of the stapler. The stapler cover is removed, and the magazine is made transparent to better illustrate the internal components.

FIG. 5 is a perspective view illustrating in detail an interface between the staple cartridge and a retainer housing within the magazine.

FIG. 6 is a perspective view illustrating the interface between the staple cartridge and the retainer housing, and illustrating the staple cartridge pushed further into the retainer housing during assembly.

FIG. 7 is a perspective view illustrating the staple cartridge being pushed down into the magazine.

FIG. 8 is a perspective view illustrating the staple cartridge after being fully seated into the magazine.

FIG. 9 is an alternate perspective view illustrating the staple cartridge after being fully seated into the magazine.

FIG. 10 is another alternate perspective view illustrating the staple cartridge after being fully seated into the magazine. The magazine is made transparent to better illustrate the internal components.

FIG. 11 is a perspective view illustrating a locking mechanism for locking the staple cartridge into the magazine.

FIG. 12 is a cross-section view of the stapler, taken along line 12-12 of FIG. 11.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

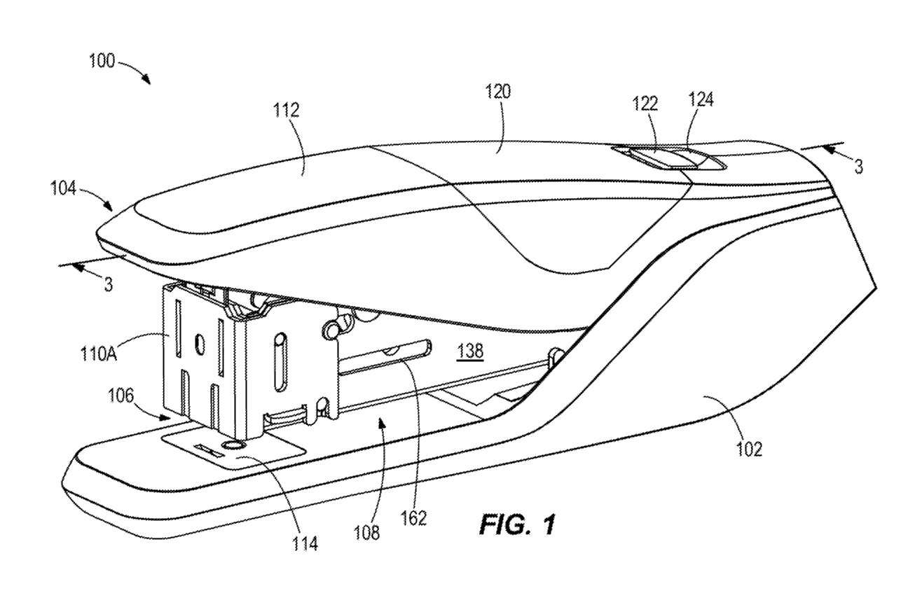

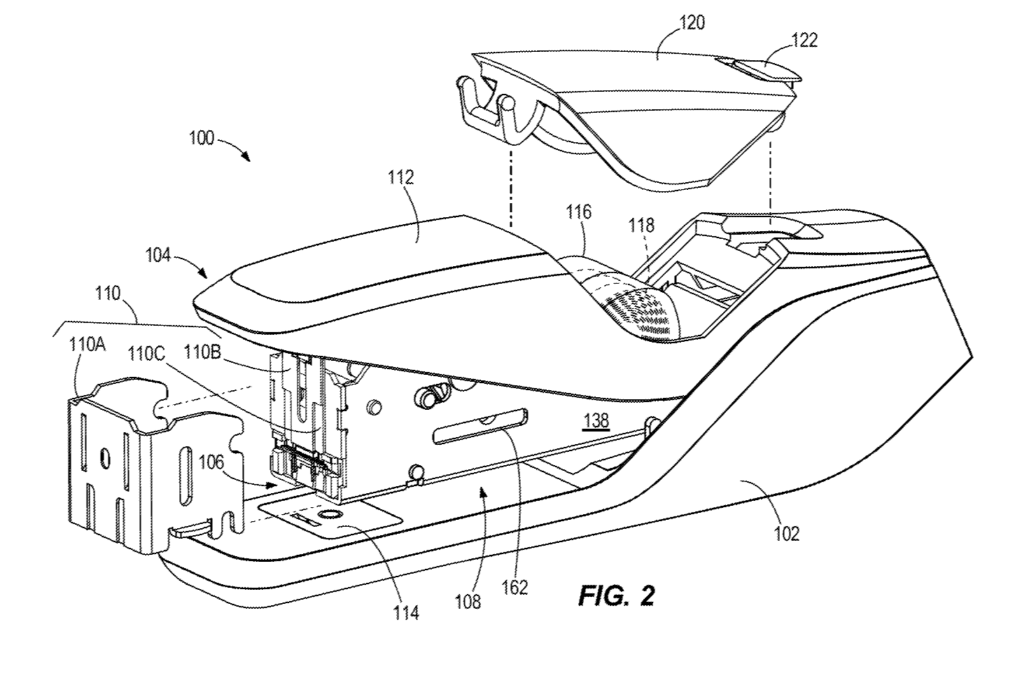

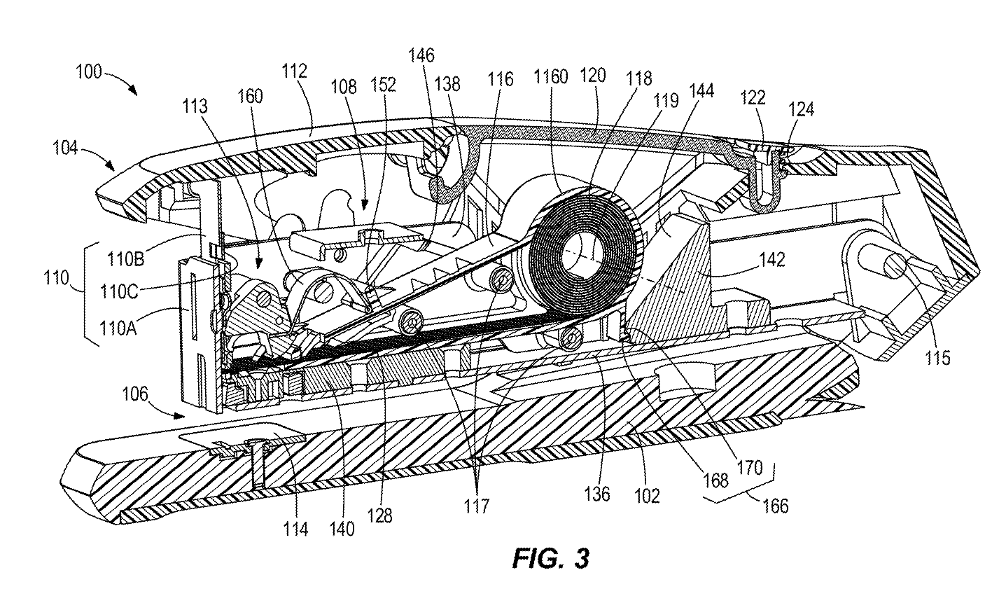

FIG. 1 illustrates a stapler 100 including a base 102 and a head 104 movably coupled to the base 102 and defining a throat 106 therebetween for receiving articles, such as paper sheets, to be stapled. The head 104 includes a magazine assembly 108, a staple forming and driving mechanism 110, and a cover 112. The base 102 includes an anvil plate 114 which cooperates with the forming and driving mechanism 110 to staple articles together when the cover 112 is depressed by a user toward the base 102. The staple forming and driving mechanism 110 includes a sheath 110A, a driver blade 110B, and a former blade 110C positioned within and movable relative to the sheath 110A. A staple feeding mechanism 113 positioned rearward of the former blade 110C advances staples forward toward the former blade 110C as the stapler is operated. A pin 115 (FIG. 3) pivotally couples the head 104 to the base 102 and also enables pivoting of the cover 112 relative to the magazine assembly 108 to drive a staple. As described further below, the magazine assembly 108 of the stapler 100 can be configured to accept staples packaged in a high capacity cartridge 116 rather than a simple unpackaged linear strip of staples. For example, the cartridge 116 can retain and dispense a continuous wound-up roll 118 of staples (e.g., flat, rather than pre-bent staples). For example, the cartridge 116 can include a central axis 119 matching a central axis of the staple roll 118. Since the number of staples loaded into the stapler 100 is not strictly limited by the length of the magazine assembly 108 when the cartridge 116 is provided, the useful life span of the stapler 100 between refills is extended dramatically. A panel 120 in the cover 112 is movable relative to the cover 112 for accessing and replacing the staple cartridge 116. The panel 120 can be moved between open and closed positions relative to the cover 112, and in some constructions, may be completely removable from the cover 112. In the illustrated construction, a latching mechanism is provided by a flexible detent 122 on the panel 120 (FIGS. 2 and 3) that selectively secures the panel 120 to the cover 112 by engaging a corresponding aperture or recess 124 in the cover 112.

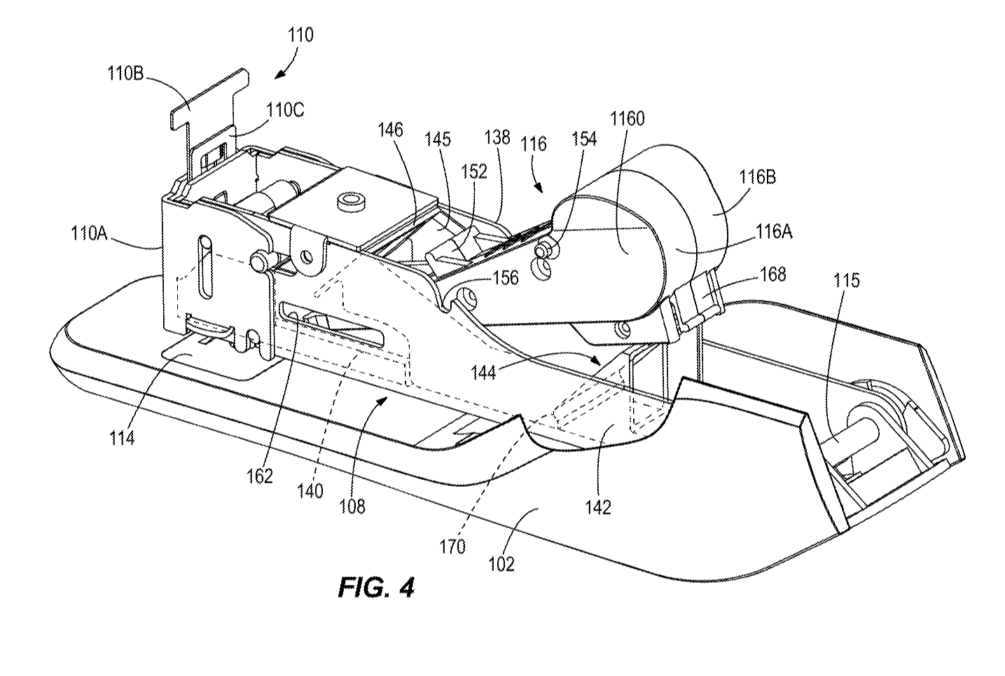

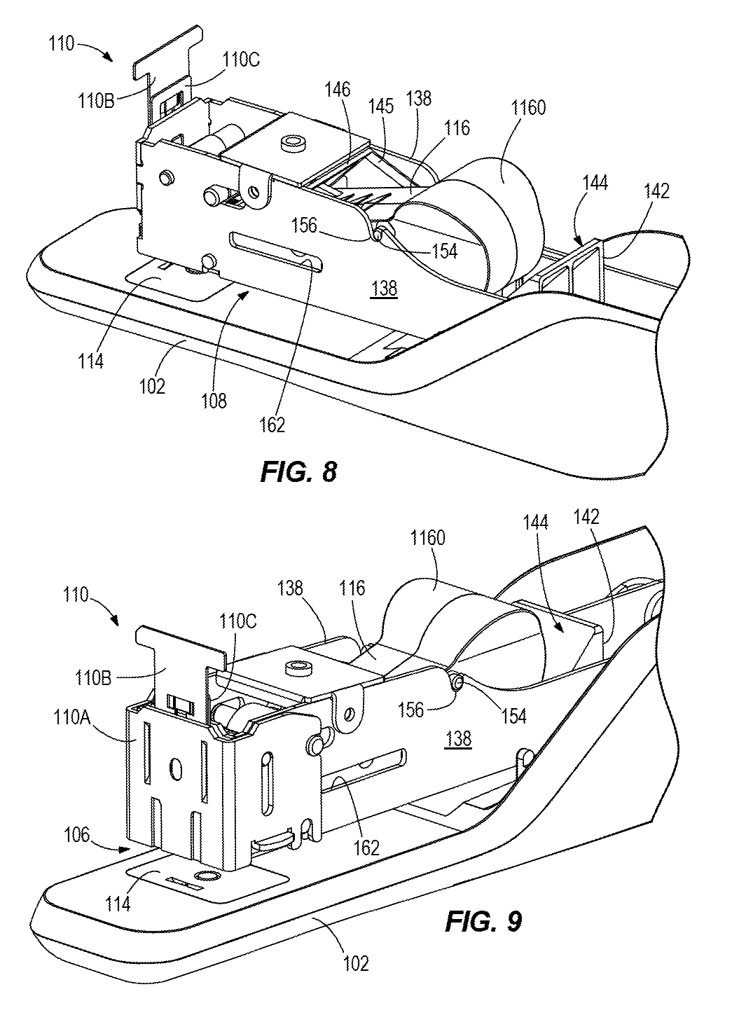

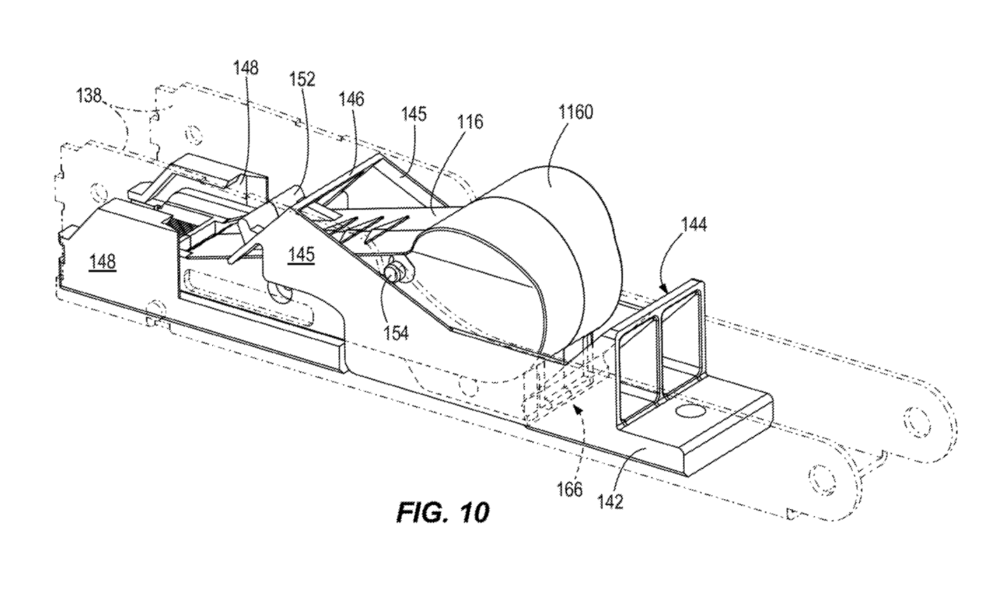

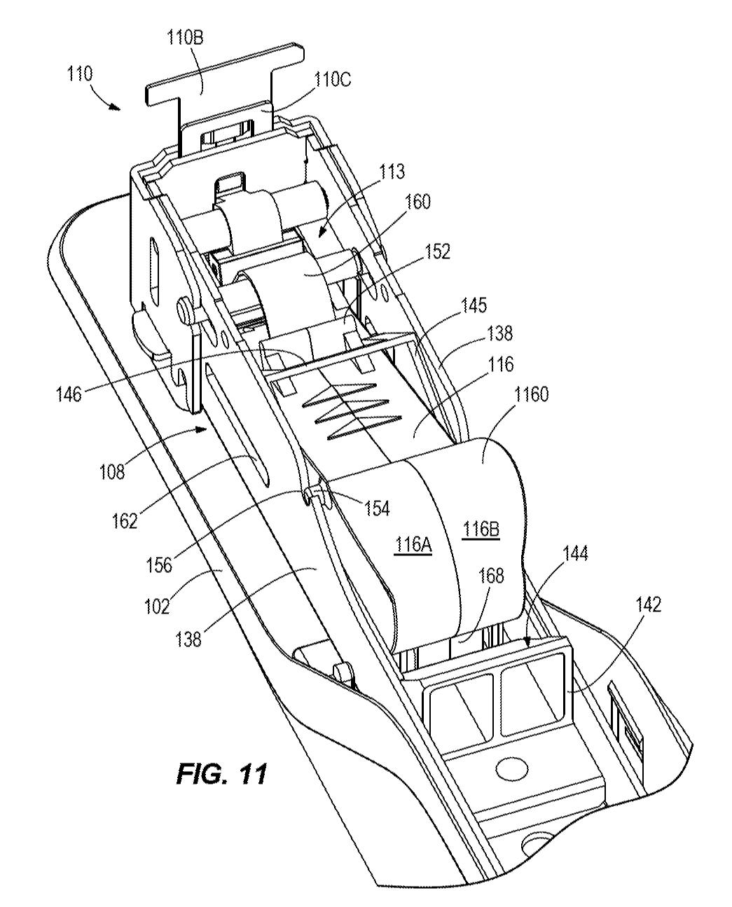

The construction of the staple cartridge 116 and its interface with the magazine assembly 108 is described in further detail with reference to FIGS. 3-12. The staple cartridge 116 includes two releasably secured portions or components 116A, 116B forming an enclosed space to receive the staple roll 118. As illustrated, the two cartridge portions 116A, 116B are respective side portions (e.g., halves) coupled together in a lateral or transverse direction (e.g., by multiple fasteners, not shown) to form a longitudinal seam. For example, one or both cartridge portions 116A, 116B can be provided with fastener bosses 117 configured to receive screws. However, the cartridge 116 can be provided by upper and lower housing halves and can be coupled together with a latching mechanism in other constructions. The cartridge 116 has a generally cylindrical shape, at least in its interior, at the rear end thereof, forming a roll storage portion 1160 for accommodating the staple roll 118 about the central axis 119. A flat bottom wall 128 of the cartridge 116 forms an outlet chute extending (e.g., linearly at a tangent) from the roll storage portion 1160. The cartridge 116 tapers in the vertical direction from the rear end toward the front end, where an outlet aperture 132 is provided to direct a row of staples from the roll 118 toward the driver mechanism 110. An upper surface of the cartridge 116, forward of the roll storage portion 1160, and in some constructions closer to the forward end of the cartridge 116 than the rear end, includes an upstanding wall 152. The wall 152 can project from the upper cartridge surface to provide an abutment for a spring engagement (e.g., for contacting a spring 160 or other biasing member of the stapler 110 when the cartridge 116 is fully inserted). In some constructions, the wall 152 can provide an abutment or backstop for the spring 160 of a staple feeder mechanism that advances staples for use by the stapler 100. As used herein, directional terms front or forward refer to the operational end of the stapler 100 and cartridge 116 where stapling occurs, while rear or rearward refer to the opposite end, typically where the pivot (e.g., pin 115) between the head 104 and the base 102 is located. Terms such as lower or bottom refer to the portion or direction at or toward the base 102 (assuming a common table top orientation of the stapler 100 as shown), while upper or top refer to the opposite portion or direction (away from the base 102). Of course, it will be understood that these terms are used for convenience of description, and the stapler 100 can be operated in any number of other orientations relative to earth.

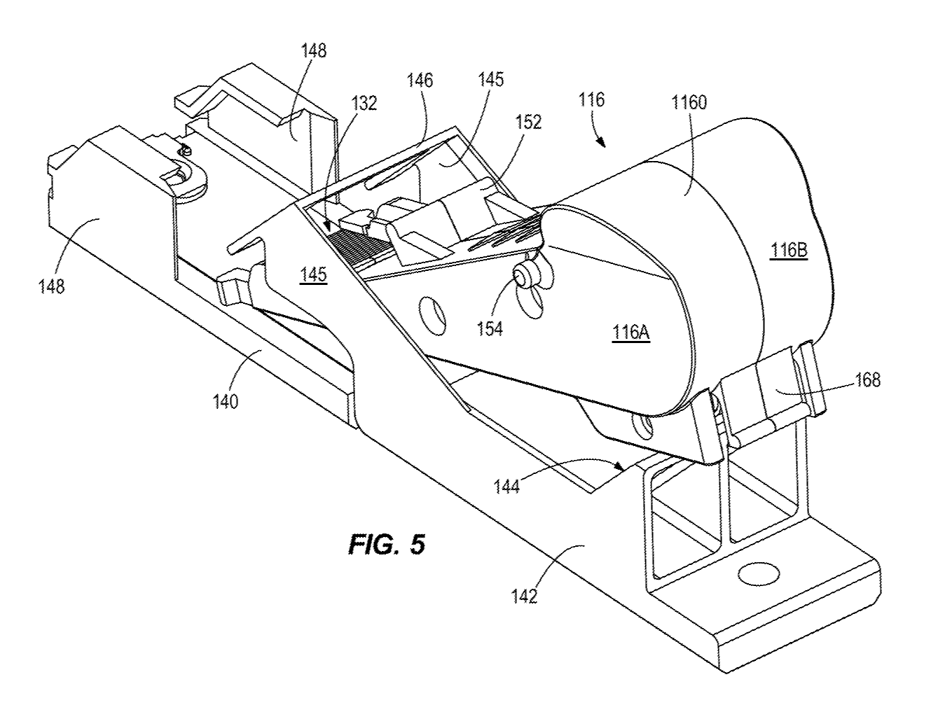

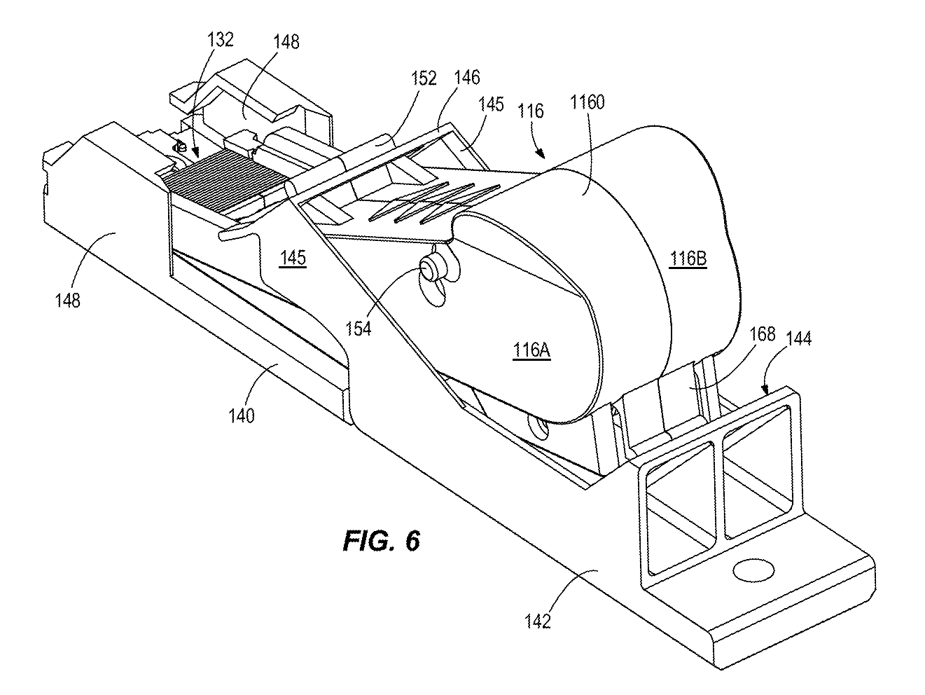

The magazine assembly 108 includes a magazine body having a bottom wall 136 and opposing side walls 138 defining an upwardly-open receiving area, and a retainer housing 140 positioned within the receiving area, against the bottom wall 136. The retainer housing 140 is secured with the magazine body (e.g., by fasteners, not shown) to prevent relative movement. In other constructions, the retainer housing 140 can be secured to the magazine body without fasteners, but rather, by latching engagement between integral portions (e.g., flexible barbs and corresponding recesses or apertures) of the retainer housing 140 and the magazine body. The width of the cartridge 116 is accommodated between two side walls 148 of the retainer housing 140 that define a channel so that side-to-side movement of the cartridge 116 is substantially prevented when the cartridge 116 is positioned between the side walls 148. During insertion, the cartridge 116 can slide forward in the channel of the retainer housing 140 as shown in FIGS. 5 and 6 until a forward portion of the cartridge 116 abuts the sheath 110A (not shown in FIGS. 5 and 6). Side wings or flanges protrude laterally outward from both sides of the cartridge 116 at the outlet aperture 132 adjacent the forward tip. These flanges are squeezed between the side walls 148 of the retainer housing 140 to prevent unwanted movement of the staples with respect to the cartridge 116. Once the forward tip of the cartridge 116 is fully seated in the forward direction with respect to the retainer housing 140, reliefs in or termination of the side walls 148 releases the squeezing force so that the staples may be freely advanced through the cartridge 116 during stapling. The rear end of the cartridge 116 is temporarily held in an elevated position with respect to the forward end.

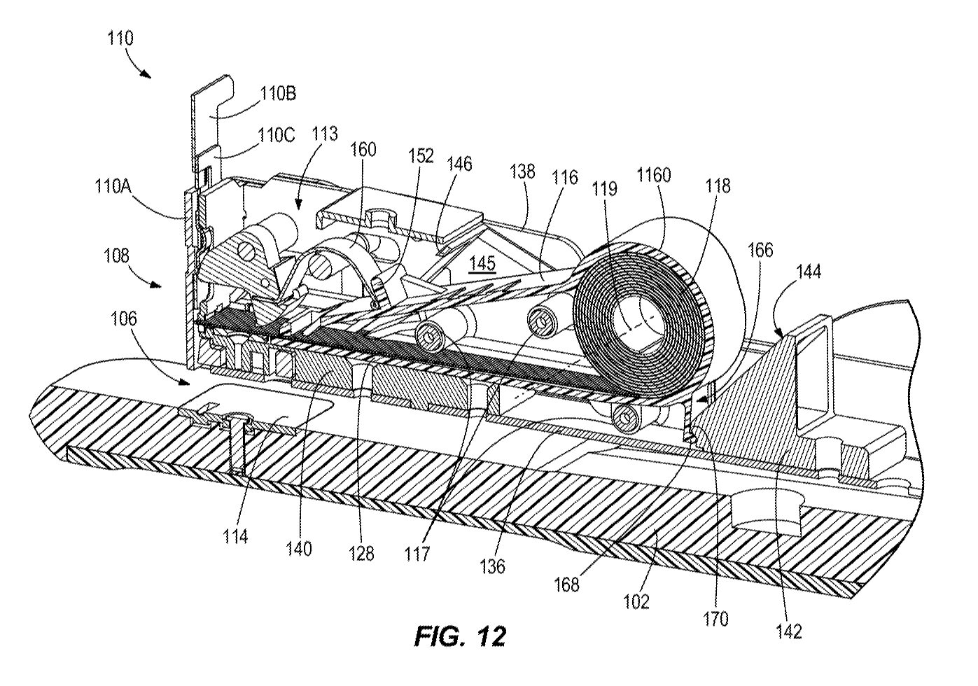

The magazine assembly 108 further includes a cartridge guide 142 as shown in FIG. 5. The cartridge guide 142 can be formed separately from the magazine body and secured thereto with fasteners, not shown, although other methods of manufacture and attachment are optional. The cartridge guide 142 includes a rearward end having a guide ramp 144 that decreases in height in the forward direction to guide a rearward, bottom edge of the cartridge 116 into position within the magazine assembly 108. Adjacent a bottom edge of the guide ramp 144, a latching member 170 may be provided for engaging a corresponding portion of the cartridge 116 in a latching manner as shown in FIGS. 3 and 12 and described in further detail below. In the illustrated construction, the latching member 170 takes the form of a fixed detent nose, although other structures are optional, such as a flexible barbed flange. The cartridge 116 fits between two side walls 145 of the guide 142. At a forward end of the guide 142, an upper wall 146 extends between the two side walls 145, such that a forward portion of the cartridge 116 must pass under the upper wall 146 during placement into the stapler 100.

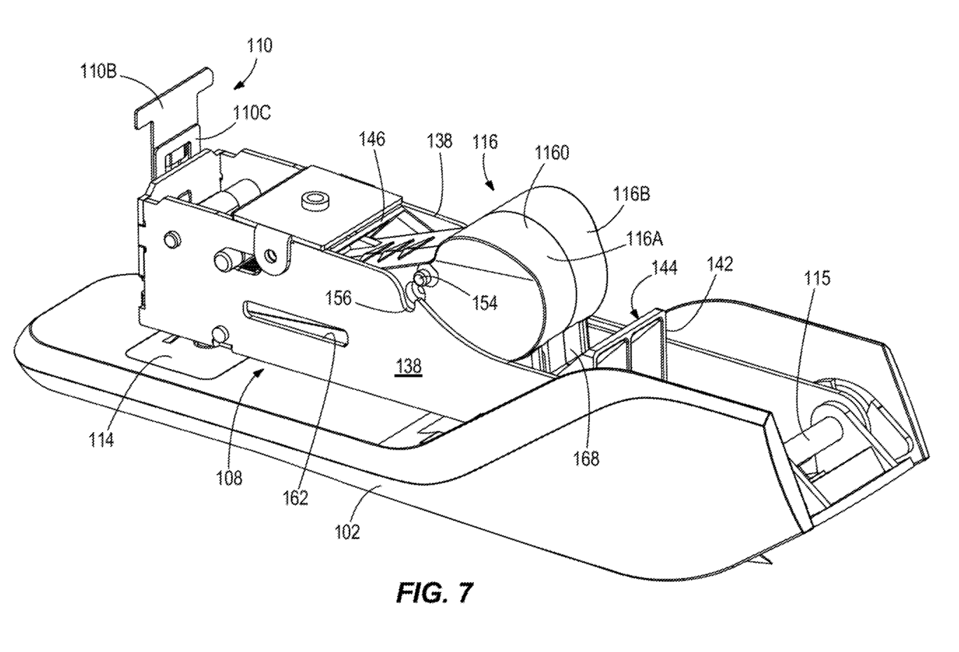

The forward end of the cartridge 116 is inserted and the rear end of the cartridge 116 is pressed downward along the guide ramp 144 toward the bottom wall 136 of the magazine body. In some constructions, an ergonomic tab or handle is provided at the rearward end of the cartridge 116, for example, extending rearwardly to provide a convenient contact point for the user to engage or grasp the cartridge 116 during insertion and/or removal. A laterally-protruding projection or post 154 is provided on each side of the cartridge 116 adjacent the top of the cartridge 116, and a corresponding notch or recess 156 is provided on each of the magazine side walls 138, at an upper edge thereof. The cartridge 116 is lowered to position the posts 154 into the recesses 156. The posts 154 may freely enter the recesses 156 without any latching mechanism and without any interference or snap-fit, such that the posts 154 are also freely removable from the recesses 156. In another construction, projections or posts may extend laterally inwardly from the side walls 138, and corresponding notches or recesses may be provided on the sides of the cartridge 116. Elongated apertures or slots 162 are provided in the side walls 138 of the magazine body as shown in FIGS. 7-11. The slots 162 form windows for viewing the cartridge 116. The area of the cartridge 116 aligning with the slots 162 can be translucent to enable viewing of the staples and identification of diminishing staple quantity within the cartridge 116 while the cartridge 116 is in the operational position within the stapler 100. This may also provide visual confirmation of proper positioning of the cartridge 116. In some constructions, the entire cartridge 116 can be constructed of a translucent material (e.g., transparent polycarbonate).

In addition to the engagement between the cartridge posts 154 and the recesses 156 in the magazine side walls 138, a latching mechanism 166 is provided between the cartridge 116 and the magazine assembly 108 to secure the position of the cartridge 116 relative to the magazine assembly 108, eliminating any degrees of freedom left available by the other points of engagement. The latching mechanism 166 can include inter-engaging latch members including, as shown, the detent nose 170 of the cartridge guide 142 and a barbed flange 168 on the cartridge 116. The barbed flange 168 can extend downwardly from the roll storage portion 1160 of the cartridge 116 below the bottom wall 128 that defines the outlet chute of the cartridge 116. In some constructions, the barb of the barbed flange 168 protrudes rearward from the flange, in a direction away from the forward end of the cartridge 116. The barbed flange 168 interferes with the detent nose 170 (e.g., in the fore-aft direction), and is flexible to allow latching and unlatching. In some constructions, the barbed flange 168 can include a barb with a rounded profile that is generally complementary with a shape of a recess immediately adjacent the detent nose 170, rather than having a sharp or flat profile. Thus, the latching mechanism 166 is configured for latching and unlatching without a dedicated releasing or unlatching member, and without the user being required to operate such member. Rather, the user can simply press down on the cartridge 116 to engage the latching mechanism 166, and the user can pull up on the cartridge 116 to release the latching mechanism 166.

The magazine assembly 108 and the cartridge 116 are mutually provided with a three-part interface. The three-part interface includes A) engagement between the forward end of the cartridge 116 and the channel of the retainer housing 140, with sliding movement limited by the sheath 110A; B) engagement between the posts 154 and the recesses 156 at the upper edge of the magazine side walls 138, which limits fore-aft sliding and secures a predetermined position of the cartridge 116 along the magazine assembly 108; and C) latching engagement between the latch members 168, 170, which resists upward movement of the cartridge 116 relative to the magazine assembly 108 to keep the posts 154 engaged in the recesses 156 until a substantial removal force is applied to the cartridge 116. The engagement between the posts 154 and the recesses 156 can be a non-latching engagement, which does not inhibit removal of the posts 154 from the recesses 156. The latching mechanism 166 can be configured so that the removal force is consistent with an amount that corresponds to a comfortable operation by an average user, while strong enough to prevent incidental detachment. With the cartridge 116 positioned in the channel of the retainer housing 140 and abutting the sheath 110A, the cartridge 116 can slide backward freely. However, engaging the posts 154 into the recesses 156 further limits freedom of movement of the cartridge 116 to prevent fore-aft sliding. The latching mechanism 166 further limits freedom of movement of the cartridge 116 by inhibiting lifting of the rearward end of the cartridge 116 from the magazine assembly 108 so that the posts 154 are kept within the recesses 156 as long as the latching mechanism 166 is in the latched condition. The latching mechanism 166 can be designed for one-direction latching (e.g., vertical), which is not particularly configured to secure the fore-aft position of the cartridge 116 since this is accomplished by the non-latching engagement between the posts 154 and the recesses 156.

As shown in FIGS. 1-3, the opening in the cover 112 that is selectively closed by the panel 120 is positioned above the roll storage portion 1160 of the cartridge 116. Releasing and partially or fully removing the panel 120 provides easy access to the cartridge 116 for removal and insertion. However, by not extending the opening further forward (i.e., by limiting the opening to the area directly above the roll storage portion 1160), the inner workings of the stapler 100 provided at its forward end are protected from inadvertent fouling.

Various features and advantages of the invention are set forth in the following claims.

What is claimed is:

1. A stapler comprising:
a base;
a head movably coupled to the base and including a magazine assembly;
a feeding mechanism operable to feed a staple from the magazine assembly;
a forming and driving mechanism operable to form and drive a staple; and
a cartridge configured to receive a roll of staples, the cartridge cooperating with the magazine assembly to define an interface, the interface including
a channel of the magazine assembly configured to slidably receive a forward end of the cartridge,
a non-latching-type engagement configured to inhibit sliding movement between the cartridge and the magazine assembly, and
a latching-type engagement configured to retain the cartridge in fixed relationship to the magazine assembly.

2. The stapler of claim 1, wherein the latching-type engagement is formed by cooperating latch members of the magazine assembly and a rear portion of the cartridge opposite an outlet aperture of the cartridge.

3. The stapler of claim 2, wherein at least one of the cooperating latch members is formed as a flexible barbed flange.

4. The stapler of claim 2, wherein the latch member of the magazine assembly includes a detent nose formed at a lower end of a guide ramp that leads the rear portion of the cartridge into the magazine assembly.

5. The stapler of claim 2, wherein the latch member of the cartridge extends downwardly toward the base from a roll storage portion of the cartridge.

6. The stapler of claim 5, wherein the latch member of the cartridge extends downwardly below a bottom wall that defines a linear outlet chute of the cartridge.

7. The stapler of claim 1, wherein the non-latching type engagement is formed by at least one post and at least one cooperating recess.

8. The stapler of claim 7, wherein the at least one post is formed on the cartridge and is arranged to protrude laterally from a side wall of the cartridge.

9. The stapler of claim 1, wherein the interface further includes a spring engagement whereby, when the cartridge is fixed to the magazine assembly via the latching-type engagement, an abutment formed on a forward portion of the cartridge is brought into contact with a spring positioned within the magazine assembly.

10. The stapler of claim 1, wherein the head includes a cover with an opening and a panel for selectively closing off the opening, wherein the opening is positioned exclusively above a roll storage portion of the cartridge.

11. A staple cartridge configured for storing and dispensing staples in a stapler, the staple cartridge comprising:
a top, a bottom, and left and right sides;
a forward end having an opening configured to dispense staples;
a rearward end having an interior space configured to hold a roll of staples having a transverse axis;
a first set of engaging features including at least one of posts and recesses provided on the left and right sides; and
a second engaging feature provided as a latching member positioned at a rearward position along the bottom of the cartridge, the latching member being configured to engage a corresponding latching member of the stapler.

12. The staple cartridge of claim 11, wherein the latching member is formed as a flexible barbed flange.

13. The staple cartridge of claim 12, wherein the flexible barbed flange is flexible in a fore-aft direction of the cartridge and is inflexible in a transverse direction of the cartridge.

14. The staple cartridge of claim 12, wherein a barb of the flexible barbed flange protrudes rearward from the flange, in a direction away from the forward end.

15. The staple cartridge of claim 11, wherein the latch member of the cartridge extends downwardly from a roll storage portion of the cartridge.

16. The staple cartridge of claim 15, wherein the latch member of the cartridge extends downwardly below a bottom wall that defines a linear outlet chute of the cartridge.

17. The staple cartridge of claim 11, wherein the first set of engaging features includes posts formed on the cartridge and arranged to protrude laterally from the left and right sides of the cartridge.

18. The staple cartridge of claim 11, wherein the first set of engaging features are provided adjacent the top of the staple cartridge.

19. The staple cartridge of claim 11, further comprising an upstanding wall extending from the top of the cartridge at a position nearer the forward end than the rearward end.

20. The staple cartridge of claim 11, wherein the cartridge includes separate left and right portions joined along a longitudinal seam extending between the forward and rearward ends.
